(19) United States
(12) Patent Application Publication
(10) Pub. No.: US 2018/0056583 A1
(43) Pub. Date: Mar. 1, 2018

(54) SHAPING DEVICE AND SHAPING METHOD

(71) Applicant: MIMAKI ENGINEERING CO., LTD., Nagano (JP)

(72) Inventors: Kazuhiro Ochi, Nagano (JP); Masakatsu Okawa, Nagano (JP)

(73) Assignee: MIMAKI ENGINEERING CO., LTD., Nagano (JP)

(21) Appl. No.: 15/691,750

(22) Filed: Aug. 31, 2017

(30) Foreign Application Priority Data
Aug. 31, 2016 (JP) 2016-169480

(51) Int. Cl. B29C 64/112; B29C 64/209; B29C 64/227; B33Y 10/00; B33Y 30/00; B29C 64/129; B29C 35/08; B29C 64/393; B33Y 50/02

(52) U.S. Cl. CPC B29C 64/112; B29C 64/209; B29C 64/227; B33Y 10/00; B33Y 30/00; B29K 2105/0058; B29C 35/0805; B29C 64/393; B33Y 50/02; B29C 2035/0827; B29C 64/129

(57) ABSTRACT

A shaping device that shapes a 3D object includes: an inkjet head, which is a discharging head and discharges a material of shaping; a main scanning driver; a layering direction driver; and a controller, where the controller causes the inkjet head to carry out a plurality of main scanning operations with respect to each position within a plane orthogonal to a layering direction, and when an amount of the material of shaping discharged from the inkjet head per unit area in one main scanning operation with respect to a region to which the material of shaping is to be discharged is defined as a unit area discharging amount, the unit area discharging amount in some main scanning operations is less than the unit area discharging amount in the other main scanning operations of the plurality of main scanning operations carried out with respect to each position.

### CROSS REFERENCE TO RELATED APPLICATIONS

This application claims the priority benefit of Japanese Patent Application No. 2016-169480, filed on Aug. 31, 2016. The entirety of the above-mentioned patent application is hereby incorporated by reference herein and made a part of this specification.

### TECHNICAL FIELD

The present disclosure relates to a shaping device and a shaping method.

### DESCRIPTION OF THE BACKGROUND ART

A shaping device (3D printer) that shapes a 3D object using a discharging head such as an inkjet head is conventionally known (see e.g., Japanese Unexamined Patent Publication No. 2015-71282). In such a shaping device, for example, the 3D object is shaped through a layering and shaping method by overlapping a plurality of layers of ink formed by the inkjet head using ink for the material of shaping.
Patent Literature 1: Japanese Unexamined Patent Publication No. 2015-71282

### SUMMARY

When shaping the 3D object through the layering and shaping method, each layer to be layered needs to be appropriately formed at high precision. Thus, the layer formed with the material of shaping is conventionally desired to have a configuration that can be formed at higher precision. The present disclosure provides a shaping device and a shaping method that can solve the problems described above.

The inventors of the present application conducted an intensive research on the method for appropriately forming a layer in an arrayed state at high precision with respect to the layer formed with the material of shaping. In this case, the layer in an arrayed state means, for example, a planar layer with little disarray. The disarray in the layer means, for example, disarray in the state of dots of the material of shaping configuring the layer. In such an intensive research, the cause of disarray in the state of the layer was first reviewed. As a result, the inventors found out that the disarray tends to easily occur in the state of the layer when an interval of the dots of the material of shaping configuring the layer becomes small.

More specifically, for example, when using ink for the material of shaping, the layer of ink is formed by forming the dots of the ink in line on a surface-to-be-shaped of the 3D object. In this case, the ink is discharged in a liquid state, and after the ink is landed on the surface-to-be-shaped, the ink is cured. In such a case, the dots tend to easily come into contact with each other if the interval of the ink dots is small. When the dots come into contact with each other, the dots of the ink in the liquid state connect with each other and may cause coupling of the ink dots. Furthermore, the pre-cured ink may flow in an unintended direction. When such coupling of dots, and the like occur, disarray of the state may occur in the layer of ink after the curing. More specifically, for example, the coupling of the dots of the ink may produce an unintended groove-like portion, and the like at the surface of the layer of ink.

Furthermore, if the interval of the dots is small, a slight shift in the positions of the adjacent dots may easily influence the state after the curing. More specifically, for example, when carrying out the discharging of the ink, which is the material of shaping, using the inkjet head, the influence of variation in the discharging property of the inkjet head (habit in discharging property) may easily occur if the interval of the dots is small. Moreover, if the interval of the dots is small, curved flight may easily occur by the influence of the closely flying ink (ink droplet) during the flight from the discharging to the landing as the ink is discharged at high density. As a result, shift in the landing position may occur, and disarray in the state may occur in the layer of ink after the curing.

The contact between the dots can be prevented from easily occurring by, for example, making the interval of the dots of the ink formed at the same time large. Thus, in this case, the layer of the material of shaping can be assumed to be formed at a higher precision. However, in such a case, the time required for shaping is greatly increased as the material of shaping discharged with respect to a unit area in a unit time is reduced. Furthermore, if the material of shaping discharged with respect to the unit area in the unit time is simply reduced, for example, problems may arise in the operation of flattening the layer.

After conducting a further intensive research, the inventors of the present application came up with an idea of changing the amount of the material of shaping discharged with respect to the unit area in the unit time in accordance with the timing during the shaping to change the interval of the dots of the ink formed at the same time according to the timing during the shaping, rather than uniformly increasing the interval of the dots of the ink formed at the same time. More specifically, for the configuration therefor, the inventors considered reducing a unit area discharging amount in some main scanning operations than a unit area discharging amount in other main scanning operations in a shaping device that causes the discharging head (inkjet head, etc.), which discharges the material of shaping, to carry out the main scanning operation (scan operation). In this case, the unit area discharging amount is, for example, the amount of material of shaping discharged from the discharging head per unit area in one main scanning operation with respect to a region to which the material of shaping is to be discharged.

When configured in such a manner, for example, the unit area discharging amount is reduced in some main scanning operations, whereby the material of shaping can be discharged in a state where disarray does not easily occur in the state of the layer. The state of the surface-to-be-shaped of the 3D object is thereby arrayed. Furthermore, in this case, for example, the disarray in the state of the layer can be prevented from easily occurring even if the unit area discharging amount is increased by carrying out the other main scanning operations at the timing when the state of the surface-to-be-shaped is arrayed. Moreover, in this case, the speed of shaping can be appropriately prevented from greatly lowering by increasing the unit area discharging amount. When flattening the layer, for example, the flattening can be more appropriately carried out by, for example, increasing the unit area discharging amount at the time of the main scanning operation for carrying out the flattening, compared to when reducing the unit area discharging amount in all the main scanning operations. Thus, according to such a configuration, for example, the layer of the material of shaping can be more appropriately formed at high precision.

Through further intensive researches, the inventors of the present application found features necessary for obtaining such effects, and contrived the present disclosure. In order to solve the problem described above, the present disclosure provides a shaping device that shapes a stereoscopic 3D object, the shaping device including: a discharging head that discharges a material of shaping; a main scanning driver that causes the discharging head to carry out a main scanning operation of discharging the material of shaping while relatively moving with respect to the 3D object in a main scanning direction set in advance; a layering direction driver that relatively moves the discharging head with respect to the 3D object in a layering direction, which is a direction in which the material of shaping is layered; and a controller that controls the operations of the discharging head, the main scanning driver, and the layering direction driver to execute an operation of shaping carried out by layering the material of shaping in the layering direction, where the controller causes the discharging head to carry out a plurality of the main scanning operations with respect to each position within a plane orthogonal to the layering direction, and defining an amount of the material of shaping discharged from the discharging head per unit area in one main scanning operation with respect to a region to which the material of shaping is to be discharged as a unit area discharging amount, the unit area discharging amount in some main scanning operations is less than the unit area discharging amount in the other main scanning operations in the plurality of main scanning operations carried out with respect to each position.

When configured in such a manner, for example, the surface-to-be-shaped of the 3D object can be arrayed by reducing the unit area discharging amount in some main scanning operations. Furthermore, for example, the disarray in the state of the layer can be prevented from easily occurring even if the unit area discharging amount in the relevant main scanning operation is increased by carrying out the other main scanning operations at the timing when the state of the surface-to-be-shaped is arrayed. Thus, according to such a configuration, for example, the layer of the material of shaping can be more appropriately formed at high precision.

In the relevant configuration, for example, the shaping device shapes the 3D object through the layering and shaping method. Furthermore, the respective layers to be layered in the layering and shaping method are forming through a multi-path method. In this case, forming the layer through the multi-path method means, for example, forming each layer through a plurality of main scanning operations. Furthermore, forming the layer through the plurality of main scanning operations means, for example, carrying out a plurality of main scanning operations with respect to each position of the surface-to-be-shaped of the 3D object in the operation of forming one layer.

In this case, consideration is made to having the unit area discharging amount in some main scanning operations less than the unit area discharging amount in other main scanning operations of the plurality of main scanning operations carried out to form one layer. According to such a configuration, for example, the respective layers can be more appropriately formed at high precision while suppressing the disarray of the state.

The shaping device preferably further includes a flattener that flattens the layer of the material of shaping. In this case, for example, the flattener flattens the layer in at least a last main scanning operation of the plurality of main scanning operations carried out to form the respective layers. Furthermore, for example, the flattener flattens the layer by scraping off one part of the material discharged during the main scanning operation of carrying out flattening.

Furthermore, in this case, the unit area discharging amount in the main scanning operation of carrying out flattening is preferably made sufficiently large by having the unit area discharging amount in the main scanning operation of carrying out flattening greater than the unit area discharging amount in other main scanning operations. According to such a configuration, for example, the operation of flattening can be more appropriately carried out. Furthermore, in this case, the unit area discharging amount is preferably reduced in the main scanning operation carried out immediately after carrying out the flattening. According to such a configuration, for example, the material of shaping can be discharged at a higher precision to the flattened surface-to-be-shaped. Thus, for example, a region to become a base of the main scanning operation carried out thereafter can be appropriately formed at a higher precision.

More specifically, in this case, for example, consideration is made to having the unit area discharging amount in the first main scanning operation of the plurality of main scanning operations carried out to form the respective layers less than the unit area discharging amount in the last main scanning operation. Furthermore, in this case, consideration is made to having the unit area discharging amount in the last main scanning operation greater than the unit area discharging amount in any other main scanning operations. Moreover, in this case, consideration is made to having the unit area discharging amount the same for all the main scanning operations other than the last main scanning operation. For example, the unit area discharging amount may be differed for every main scanning operation with respect to the plurality of main scanning operations carried out to form the respective layers. In this case, for example, consideration is made to having the unit area discharging amount in the main scanning operation carried out first less than the unit area discharging amount in the main scanning operation carried out next.

Consideration is also made to using the shaping method, and the like having the features similar to the above for the configuration of the present disclosure. In this case as well, for example, effects similar to the above can be obtained.

According to the present disclosure, a layer of a material of shaping can be more appropriately formed at a high precision when shaping a 3D object.

### BRIEF DESCRIPTION OF THE DRAWINGS

FIGS. 1A to 1C are views showing one example of a shaping device 10 according to one embodiment of the present disclosure. FIG. 1A shows one example of a configuration of a main part of the shaping device 10. FIG. 1B shows one example of a configuration of a head unit 12. FIG. 1C shows one example of a configuration of a 3D object 50 along with a support layer 52.

FIGS. 2A to 2C are views describing an operation of forming a layer of ink through a multi-pass method in the present example. FIG. 2A shows one example of a region set in an inkjet head 102 in correspondence with each path. FIG. 2B shows an operation of forming one layer of ink through the multi-pass method. FIG. 2C shows a state of flattening the layer of ink.

FIGS. 3A and 3B are views describing a setting of the amount of ink discharged in each path. FIG. 3A shows one example of the setting of the amount of ink discharged in each path. FIG. 3B shows a set value in a setting B in correspondence with regions 202a to 202d in the inkjet head 102.

FIG. 4 is a view showing one example of an operation of a small pitch multi-path method.

### DETAILED DESCRIPTION OF EMBODIMENTS

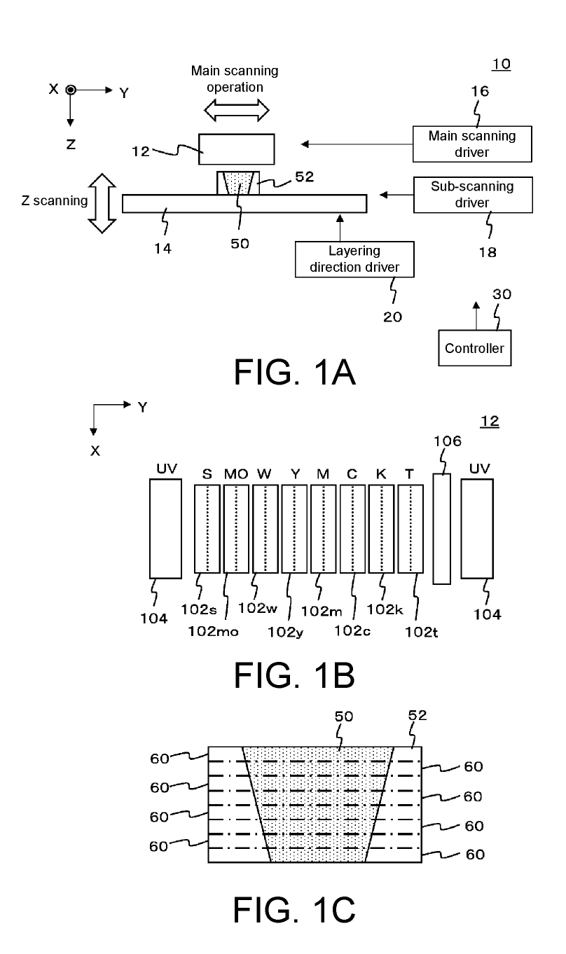

Hereinafter, an embodiment according to the present disclosure will be described with reference to the drawings. FIGS. 1A to 1C show one example of a shaping device 10 according to one embodiment of the present disclosure. FIG. 1A shows one example of a configuration of a main part of the shaping device 10.

Other than the points described below, the shaping device 10 may have a configuration same as or similar to a known shaping device. More specifically, other than the points described below, the shaping device 10 may have a configuration same as or similar to, for example, a known shaping device that carries out shaping by discharging liquid droplet, which is to become a material of a 3D object 50, using an inkjet head. Furthermore, other than the illustrated configuration, the shaping device 10 may further include, for example, various types of configurations necessary for shaping, coloring, and the like of the 3D object 50.

In the present example, the shaping device 10 is a device that shapes the 3D object 50 through the layering and shaping method. In this case, the layering and shaping method is, for example, a method for shaping the 3D object 50 by layering a plurality of layers, each being formed with the material of shaping. The 3D object 50 is, for example, a stereoscopic three-dimensional structure. In the present example, the shaping device 10 includes a head unit 12, a shaping table 14, a main scanning driver 16, a sub-scanning driver 18, a layering direction driver 20, and a controller 30.

The head unit 12 is a portion that discharges the liquid droplet (ink droplet) of the ink to become the material of the 3D object 50, and discharges the ink, which is cured according to a predetermined condition, and cures the ink to form each layer configuring the 3D object 50 in an overlapping manner. Furthermore, in the present example, an ultraviolet curing type ink that is cured by irradiation of an ultraviolet ray is used for the ink. In this case, the ink is, for example, liquid discharged from the inkjet head. The inkjet head is, for example, a discharging head that discharges the ink droplet through an inkjet method.

In the present example, the head unit 12 includes at least a plurality of inkjet heads and an ultraviolet light source. The head unit 12 further discharges a material of a support layer 52, in addition to the material of the 3D object 50. In this case, the support layer 52 is, for example, a layered structure that supports the 3D object 50 by surrounding the outer periphery of the 3D object 50 being shaped. The support layer 52 is formed as necessary during the shaping of the 3D object 50, and removed after the shaping is completed. A more specific configuration of the head unit 12 will be described in detail later.

The shaping table 14 is a table-like member that supports the 3D object 50 being shaped, and is arranged at a position facing the inkjet head in the head unit 12, where the 3D object 50 being shaped is mounted on an upper surface thereof. In the present example, the shaping table 14 has a configuration in which at least the upper surface is movable in a layering direction, where at least the upper surface is moved in accordance with the progress in the shaping of the 3D object 50 by being driven by the layering direction driver 20. In this case, the layering direction refers to, for example, a direction in which the material of shaping is layered in the layering and shaping method. More specifically, in the present example, the layering direction is a direction (Z direction in the figure) orthogonal to a main scanning direction (Y direction in the figure) and a sub-scanning direction (X direction in the figure) set in advance in the shaping device 10.

The main scanning driver 16 is a driver that causes the head unit 12 to carry out a main scanning operation (Y scanning). In this case, causing the head unit 12 to carry out the main scanning operation means, for example, causing the inkjet head of the head unit 12 to carry out the main scanning operation. Furthermore, the main scanning operation refers to, for example, an operation of discharging the ink, which is the material of shaping, while moving in the main scanning direction.

Moreover, in the present example, the main scanning driver 16 causes the head unit 12 to carry out the main scanning operation by fixing the position of the shaping table 14 in the main scanning direction and moving the head unit 12 side. The movement of the head unit 12 in the main scanning direction may be a relative movement with respect to the 3D object 50. Thus, in a variant of the configuration of the shaping device 10, for example, the 3D object 50 side may be moved by fixing the position of the head unit 12 and, for example, moving the shaping table 14.

At the time of the main scanning operation in the present example, the main scanning driver 16 further carries out the drive of the ultraviolet light source in the head unit 12. More specifically, the main scanning driver 16, for example, turns ON the ultraviolet light source at the time of the main scanning operation to cure the ink that landed on a surface-to-be-shaped of the 3D object 50. The surface-to-be-shaped of the 3D object 50 is, for example, a surface where a next layer of ink is to be formed by the head unit 12.

The sub-scanning driver 18 is a driver that causes the head unit 12 to carry out the sub-scanning operation (X scanning). In this case, causing the head unit 12 to carry out the sub-scanning operation means, for example, causing the inkjet head of the head unit 12 to carry out the sub-scanning operation. The sub-scanning operation is, for example, an operation of relatively moving with respect to the shaping table 14 in a sub-scanning direction orthogonal to the main scanning direction. More specifically, the sub-scanning operation is an operation of relatively moving with respect to the shaping table 14 in the sub-scanning direction by a feeding amount set in advance.

In the present example, the sub-scanning driver 18 causes the head unit 12 to carry out the sub-scanning operation between the main scanning operations. In this case, the sub-scanning driver 18 causes the head unit 12 to carry out the sub-scanning operation by, for example, fixing the position of the head unit 12 in the sub-scanning direction and moving the shaping table 14. Furthermore, the sub-scanning driver 18 may cause the head unit 12 to carry out the sub-scanning operation by fixing the position of the shaping table 14 in the sub-scanning direction and moving the head unit 12.

The layering direction driver 20 is a driver that moves at least one of the head unit 12 or the shaping table 14 in the layering direction (Z direction). In this case, moving the head unit 12 in the layering direction means, for example, moving at least the inkjet head in the head unit 12 in the layering direction. Furthermore, moving the shaping table 14 in the layering direction means, for example, moving the position of at least the upper surface in the shaping table 14. Moreover, the layering direction driver 20 causes the inkjet head to carry out the scanning (Z scanning) in the Z direction by moving at least one of the head unit 12 or the shaping table 14 in the layering direction to adjust the relative position of the inkjet head with respect to the 3D object 50 being shaped in the layering direction. More specifically, in the present example, the layering direction driver 20, for example, fixes the position of the head unit 12 in the layering direction and moves the shaping table 14. The layering direction driver 20 may fix the position of the shaping table 14 in the layering direction and move the head unit 12.

The controller 30 is, for example, a CPU of the shaping device 10, and causes the shaping device 10 to execute the operation of shaping of the 3D object 50 by controlling each unit of the shaping device 10. In this case, the operation of the shaping of the 3D object 50 is, for example, an operation of shaping carried out by layering the material of shaping in the layering direction. In this case, the controller 30 controls each unit of the shaping device 10 based on, for example, shape information, color image information, and the like of the 3D object 50 to be shaped. According to the present example, the 3D object 50 can be appropriately shaped.

Now, a more specific configuration of the head unit 12 will be described. FIG. 1B shows one example of a configuration of a head unit 12. In the present example, the head unit 12 includes a plurality of inkjet heads. Each inkjet head has a nozzle row, in which a plurality of nozzles are lined in a predetermined nozzle row direction, on a surface facing the shaping table 14. The shaping device 10 discharges the material from the plurality of nozzle rows in the head unit 12 to shape the 3D object 50.

More specifically, in the present example, the nozzle row direction is a direction parallel to the sub-scanning direction. The head unit 12 also includes the plurality of inkjet heads, a plurality of ultraviolet light sources 104, and a flattening roller 106. Furthermore, as shown in FIG. 1B, the plurality of inkjet heads include an inkjet head 102s, an inkjet head 102mo, an inkjet head 102w, an inkjet head 102y, an inkjet head 102m, an inkjet head 102c, an inkjet head 102k, and an inkjet head 102t. Such a plurality of inkjet heads are, for example, arranged so as to be lined in the main scanning direction with the position in the sub-scanning direction aligned.

The inkjet head 102s is an inkjet head that discharges the material of the support layer 52. In the present example, an ultraviolet curing type ink, which cure degree by the ultraviolet ray is weaker than the material of the 3D object 50, is used for the material of the support layer 52. Thus, the inkjet head 102s discharges the ultraviolet curing type ink, which becomes the material of the support layer 52, from each nozzle in the nozzle row. A water soluble material that can be dissolved with water after the shaping of the 3D object 50 is preferably used for the material of the support layer 52. Moreover, a known material for the support layer, for example, can be suitably used for the material of the support layer 52.

The inkjet head 102mo is an inkjet head that discharges a shaping material ink (Mo ink), and discharges the shaping material ink from each nozzle in the nozzle row. In this case, the shaping material ink is, for example, an ink dedicated for shaping used for the shaping of the interior (internal region) of the 3D object 50.

The ink for the interior of the 3D object 50 is not limited to the shaping material ink, and the interior of the 3D object may be formed by further using an ink of another color. For example, consideration is made to forming the interior of the 3D object 50 with only an ink of another color (e.g., white ink, etc.) without using the shaping material ink. In this case, the inkjet head 102mo may be omitted in the head unit 12.

The inkjet head 102w is an inkjet head that discharges a white (W) ink, and discharges the white ink from each nozzle in the nozzle row. In the present example, the white ink is an example of an ink having a light reflecting property, and for example, is used when forming a region (light reflecting region) having a property of reflecting light in the 3D object 50. The light reflecting region, for example, reflects the light entering from outside the 3D object 50 when carrying out coloring in a color representation by the subtractive color mixing method on the surface of the 3D object 50.

The inkjet head 102y, the inkjet head 102m, the inkjet head 102c, and the inkjet head 102k (hereinafter referred to as inkjet heads 102y to 102k) are inkjet heads for coloring used when shaping the colored 3D object 50, and respectively discharges the respective ink of the ink (decorating ink) of a plurality of colors used for the coloring from each nozzle in the nozzle row. More specifically, the inkjet head 102y discharges an yellow (Y) ink. The inkjet head 102m discharges a magenta (M) ink. The inkjet head 102c discharges a cyan (C) ink. The inkjet head 102k discharges a black (K) ink. In this case, each color of YMCK is an example of a process color used for color representation. The inkjet head 102t is an inkjet head that discharges a clear ink, and discharges the clear ink from each nozzle in the nozzle row. The clear ink is, for example, a clear ink, which is a colorless transparent (T) color.

The plurality of ultraviolet light sources 104 are light sources (UV light sources) for curing the ink, and generate an ultraviolet ray for curing the ultraviolet curing type ink. Furthermore, in the present example, each of the plurality of ultraviolet light sources 104 is arranged at each of one end side and another end side in the main scanning direction in the head unit 12 so as to sandwich the arrangement of the inkjet heads in between. An UVLED (ultraviolet LED), and the like, for example, can be suitably used for the ultraviolet light source 104. Furthermore, consideration is also made to using a metal halide lamp, a mercury lamp, and the like for the ultraviolet light source 104.

The flattening roller 106 is a flattener that flatten the layer of ink formed during the shaping of the 3D object 50, and for example, flattens the layer of ink by making contact with the surface of the layer of ink at the time of the main scanning operation and removing one part of the pre-cured ink. In this case, removing one part of the pre-cured ink means, for example, scraping off one part of the pre-cured ink by the rotation of the flattening roller 106.

The layer of ink configuring the 3D object 50 can be appropriately formed using the head unit 12 having the above configuration. Furthermore, the 3D object 50 can be appropriately shaped by forming a plurality of layers of ink in an overlapping manner.

A specific configuration of the head unit 12 is not limited to the configuration described above, and various modifications can be made. For example, in addition to the inkjet heads 102y to 102k, the head unit 12 may further include inkjet heads for colors such as a light color of each color, R (red), G (green), B (blue), orange, and the like for the inkjet heads for coloring. Furthermore, the manner of arranging the plurality of inkjet heads in the head unit 12 can also be variously modified. For example, the positions in the sub-scanning direction of some inkjet heads may be shifted from the other inkjet heads.

As shown in the figure, in the present example, the head unit 12 includes the flattening roller 106 only on one side of the arrangement of the inkjet heads 102s to 102t. In this case, for example, the flattening roller 106 flattens the layer of ink only at the time of the main scanning operation in which the flattening roller 106 is moved on the backward side of the inkjet heads 102s to 102t. More specifically, in the present example, the main scanning driver 16 causes the head unit 12 to carry out the reciprocate main scanning operation. In this case, causing the head unit to carry out the reciprocate main scanning operation means causing the head unit 12 to carry out a forward main scanning operation in which the head unit 12 moves in one way in the main scanning direction, and a backward main scanning direction in which the head unit 12 moves in the other way. In this case, the flattening roller 106 flattens the layer of ink at the time of either the forward or the backward main scanning operation. Furthermore, in this case, the flattening roller 106 flattens the layer by, for example, scraping off one part of the ink discharged during the main scanning operation of carrying out flattening. Moreover, in this case, the layer of ink may be flattened only at the time of some main scanning operations according to the height of the ink to be layered.

Next, the operation of shaping the 3D object 50 in the present example will be described in further detail. FIG. 1C is a view showing one example of a configuration of the 3D object 50 shaped by the shaping device 10 in the present example along with the support layer 52.

As described above, in the present example, the shaping device 10 shapes the 3D object 50 through the layering and shaping method by layering a plurality of layers 60 of ink formed with the ink, which is the material of shaping. In this case, the layer 60 including a portion corresponding to each region of the 3D object 50 and the support layer 52 is formed using the plurality of inkjet heads 102s to 102t in the head unit 12.

In FIG. 1C, the configuration of the 3D object 50 and the support layer 52 is schematically shown with the number of layers 60 configuring the 3D object 50 and the support layer 52 reduced for the sake of convenience of explanation. In the actual configuration, for example, the shaping device 10 forms the 3D object 50 and the support layer 52 by overlapping a thin layer 60 having a thickness of smaller than or equal to 100 μm in great numbers. In this case, the thickness of the layer 60 is the thickness in the layering direction. More specifically, the thickness of each layer 60 is, for example, about 10 to 100 μm, and preferably about 20 to 50 μm.

In this case, the layer 60 is a portion configuring a cross-section of the 3D object 50, and for example, is formed based on slice data indicating the cross-sectional shape of the 3D object 50 to be shaped. In this case, one layer 60 is formed based on one piece of slice data. Each layer 60 is formed based on the slice data different from each other.

At the time of forming the layer 60, the ink is discharged from the plurality of inkjet heads 102s to 102t in the head unit 12 to a discharging position of the ink set according to a resolution of shaping within a plane (XY plane) parallel to the main scanning direction and the sub-scanning direction. Furthermore, in this case, the layer 60 may be considered as, for example, a portion formed by discharging a predetermined amount of ink to all the discharging positions in the cross-section of the 3D object 50. Discharging a predetermined amount of ink to all the discharging positions means, for example, discharging the ink to the positions of all the points corresponding to the set resolution of shaping. In this case, even if the ink is not necessarily discharged to all the discharging positions, a state in which the ink is discharged to the positions of a preset ratio of all the discharging positions may be considered as a state in which the layer 60 is formed. In this case, the preset ratio is, for example, a ratio at which an ink of an amount sufficient to fill the region for forming the layer 60 can be discharged.

In the present example, the shaping device 10 forms each layer 60 through a multi-path method. In this case, forming the layer 60 through the multi-path method means, for example, forming each layer 60 through a plurality of main scanning operations. Furthermore, forming the layer 60 through the plurality of main scanning operations means, for example, carrying out a plurality of main scanning operations with respect to each position of the surface-to-be-shaped of the 3D object 50 in the operation of forming one layer 60. In this case, the controller 30 causes the head unit 12 to carry out the plurality of main scanning operations with respect to each position within the plane orthogonal to the layering direction.

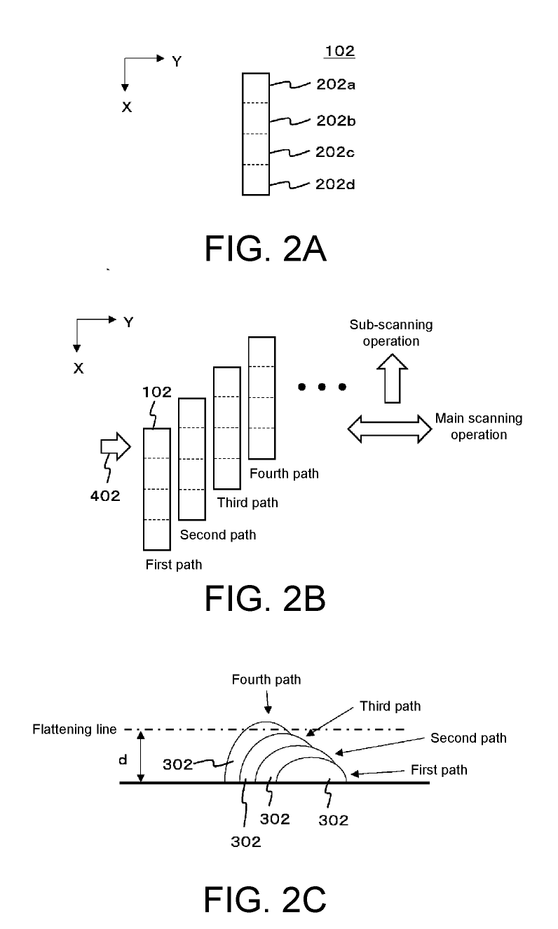

FIGS. 2A to 2C are views describing the operation of forming the layer of ink through the multi-path method in the present example. FIG. 2A is a view showing one example of a region set in the inkjet head 102 in correspondence with each path. In this case, the region set in the inkjet head 102 in correspondence with the each path is a region where the nozzles that discharge the ink in each path are lined.

In FIG. 2A, a plurality of regions 202a to 202d are shown for a case in which the number of paths is four (case of four paths). Each of the plurality of regions 202a to 202d is a region corresponding to each of the first to fourth paths. Furthermore, in the present example, each of the plurality of regions 202a to 202d is a region in which a width in the sub-scanning direction is equal, and respectively includes the same number of nozzles.

In FIGS. 2A to 2C, the inkjet head 102 is an inkjet head shown as a representative of the inkjet heads 102s to 102t in the head unit 12 (see FIGS. 1A to 1C). In this case, in each of the inkjet heads 102s to 102t, the plurality of regions 202a to 202d are set, similar to the illustrated inkjet head 102.

FIG. 2B is a view showing an operation of forming one layer of ink through the multi-path method, and shows an example of the position of the inkjet head 102 in the sub-scanning direction for the main scanning operation corresponding to each of the first to fourth paths carried out with respect to the region indicated with an arrow 402. In this case, the region indicated with the arrow 402 is, for example, a region where the position indicated with the arrow 402 and the position in the sub-scanning direction overlap.

When forming the layer of ink through the multi-path method as shown in the figure, the sub-scanning driver 18 (see FIGS. 1A to 1C) in the shaping device 10 sets a feeding amount at the time of the sub-scanning operation to a width corresponding to the number of paths, for example, and causes the head unit 12 to carry out the sub-scanning operation. In this case, with respect to the feeding amount, the width corresponding to the number of paths is, for example, a width equal to a distance obtained by dividing the nozzle row length of the inkjet head 102 by the number of paths. The nozzle row length is, for example, the length of the nozzle row in the sub-scanning direction. The nozzle row length may be a substantive length of the nozzle row in the sub-scanning direction. More specifically, in the illustrated case, the feeding amount is ¼ of the nozzle row length. In this case, the sub-scanning driver 18 causes the head unit 12 to carry out the sub-scanning operation at the feeding amount worth the path width between each main scanning operation. Thus, the region in the inkjet head 102 facing each position of the 3D object 50 being shaped is sequentially changed.

As also described above, in the present example, the main scanning driver 16 (see FIGS. 1A to 1C) causes the head unit 12 to carry out the reciprocate main scanning operation. The flattening roller 106 (see FIGS. 1A to 1C) flattens the layer of ink at the time of either the forward or the backward main scanning operation. More specifically, in the case shown in FIG. 2B, the first path and the third path are the forward main scanning operations. The second path and the fourth path are the backward main scanning operations. The flattening roller 106 flattens the layer of ink at the time of the backward main scanning operation.

However, in the actual operation of shaping, the flattening roller 106 flattens the layer of ink only when brought into contact with the ink configuring the layer of ink. In design, the movement amount in the layering direction carried out by the layering direction driver 20 (see FIGS. 1A to 1C) is set such that, for example, only the ink discharged in the last path carried out in the formation of the respective layers of ink makes contact with the flattening roller 106.

More specifically, for example, the layering direction driver 20 increases the distance between the inkjet head and the shaping table 14 (see FIGS. 1A to 1C) by the thickness of one layer every time one layer of ink is formed. Thus, at the time of forming each layer, the ink discharged in the initial path normally is not brought into contact with the flattening roller 106. Furthermore, in this case, the movement amount in the layering direction is set such that the thickness of the layer is sufficiently thick and the ink and the flattening roller 106 are brought into contact at the time point when the main scanning operation worth the number of paths has been carried out. Thus, the flattening roller 106 flattens the layer at least in the last path of a plurality of paths (main scanning operations) carried out to form each layer. In the present example, the movement amount in the layering direction carried out every time one layer of ink is formed is set such that, in design, the ink and the flattening roller 106 are brought into contact only in the last path. Therefore, in the case of the operation shown in the figure, for example, only the ink discharged in the fourth path is brought into contact with the flattening roller 106 in design.

FIG. 2C is a view showing a state of flattening the layer of ink, and schematically shows an overlapping manner of dots 302 of the ink discharged to close positions in each path and one example of a height (flattening line) for carrying out the flattening. In this case, the flattening line is, for example, the position of the lower end of the flattening roller 106. The lower end of the flattening roller 106 is, for example, a portion closest to the shaping table 14 in the flattening roller 106.

At the time of shaping the 3D object, the time required for layering increases if the amount of ink discharged from each nozzle of the inkjet head is small. As a result, the shaping speed of the 3D object greatly lowers. Thus, at the time of shaping the 3D object, the amount of ink discharged from the nozzle in one discharge is usually made greater than or equal to a certain extent. More specifically, for example, consideration is made to setting the amount of ink discharged from the nozzle in one discharge such that a diameter (dot gain) of the dot 302 of the ink formed after landing in a plane orthogonal to the layering direction becomes greater than an interval (dot pitch) corresponding to the resolution of shaping. In this case, when the dot gain becomes large, overlapping occurs between the dots 302 formed at close positions in the other paths. Thus, in this case, the dot of the ink formed in each path is, for example, formed so as to be sequentially overlapped, as shown in the figure.

In this case, the flattening line is, for example, set in accordance with the design thickness of the layer of ink to be formed. More specifically, when attempting to have the thickness of the layer of ink after the flattening to a predetermined thickness d, the head unit 12 is relatively moved with respect to the shaping table 14 so that the distance between the inkjet head and the shaping table 14 becomes large by d by the layering direction driver 20 after the formation of the underlying layer. Thus, the height where the lower end of the flattening roller 106 passes in the head unit 12 is set to a position spaced apart by the distance d from the underlying layer. According to such a configuration, for example, the flattening line can be appropriately set, as shown in the figure.

Furthermore, in this case, the height of the layer of ink being formed gradually becomes higher every time the ink is discharged in each path. In this case, assuming a height of the ink reached in each path when the flattening is not carried out, the thickness d of the layer of ink after the flattening is, in design, set so as to be higher than an assumed height reached before the path immediately before the last and lower than the assumed height reached after the completion of the last path. According to such a configuration, for example, only the ink discharged in the last path can be brought into contact with the flattening roller 106 in tennis of design. Therefore, according to such a configuration, the flattening of the layer of ink can be appropriately carried out at least in terms of design.

However, when the position of the dot of each ink is locally seen in the actual shaping, the height of each position of the layer of ink does not necessarily coincide with the design height. Thus, when carrying out the shaping through the conventional method, for example, the height of the layer of ink may locally reach the flattening line at one part of the layer of ink at a stage when the path immediately before the last is carried out. Furthermore, in particular, when carrying out the shaping at high resolution, the dots of the ink are formed at high density, and thus such shift in height is assumed to occur easily.

Furthermore, when carrying out the shaping through the multi-path method, the dot of the ink discharged in each path is usually irradiated with the ultraviolet ray and cured during the main scanning operation. Thus, if the height is shifted, an unintended contact of the cured ink dot and the flattening roller 106 occurs in the last path to carry out the flattening. When such a contact is made, the layer of ink may not be appropriately flattened. More specifically, for example, the cured ink may be scraped, and extra shaving and the like may be produced. Furthermore, consideration may be made that the flattening roller 106 may vibrate by the contact, thus influencing the operation of flattening. As a result, it may become difficult to appropriately carry out flattening at high precision.

In the present example, on the other hand, the occurrence of such problems is suppressed by adjusting the setting of the amount of ink discharged in each path. The setting of the amount of ink discharged in each path in the present example will be described below.

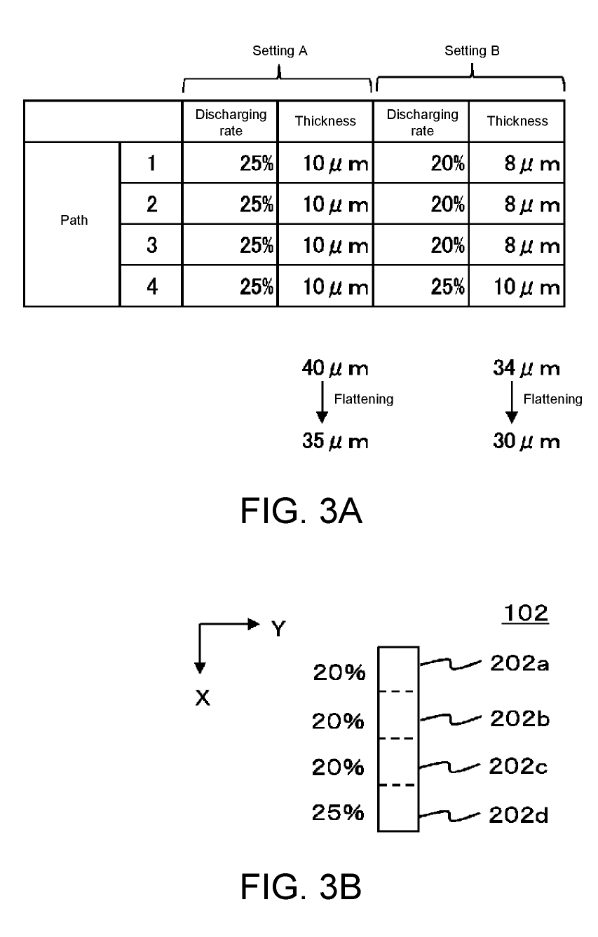

FIGS. 3A and 3B are views describing the setting of the amount of ink discharged in each path. FIG. 3A is a view showing one example of the setting of the amount of ink discharged in each path, and shows a setting A, which is the setting in the conventional configuration, and a setting B, which is the setting in the present example, in comparison. FIG. 3B shows a set value in the setting B in correspondence with the regions 202a to 202d in the inkjet head 102.

When carrying out the shaping through the multi-path method of the conventional configuration, the amount of ink discharged in each path is usually set the same in all the paths. Thus, for example, when the number of paths is four, and the total amount of ink discharged in all the paths is 100%, the amount of ink discharged in each path (discharging rate) becomes 25%, as shown as the setting A in the figure. In this case, the discharging amount of 25% can be considered as the maximum discharging amount set according to the number of paths. The maximum discharging amount set according to the number of paths is, for example, the discharging amount of a ratio obtained by dividing 100% by the number of paths. Furthermore, in this case, the amount of ink of 100% is, for example, the amount of ink of when a predetermined amount (e.g., worth one dot) of ink is discharged to all the points corresponding to the resolution of shaping within the plane orthogonal to the layering direction.

In this case, the thickness of the layer of ink at the time point when each path is completed becomes higher substantially in proportion with the completed number of paths. More specifically, for example, when discharging the ink corresponding to the thickness of 40 μm in four paths, the thickness of the layer of ink increases by 10 μm every time the ink is discharged in each path. In other words, in this case, the thickness of the ink for one path can be considered as 10 μm.

Furthermore, in this case, the thickness of the layer of ink at the time point when all the paths are completed becomes smaller than 40 μm by flattening. More specifically, for example, consideration can be made to having the thickness of the layer of ink after the flattening to about 35 μm by removing one part of the ink discharged in the last path with the flattening roller. However, in this case, the cured ink dot and the flattening roller 106 are brought into contact and it may become difficult to appropriately carry out flattening at high precision, as described above.

On the contrary, in the present example, the amount of ink discharged in the paths other than the last path is made smaller than the amount of ink discharged in the last path, as shown as the setting B in the figure, instead of setting the amount of ink discharged in each path to be the same in all the paths. More specifically, for example, the amount of ink discharged in the last path is set the same as in the case of the setting A. In this case, assuming the total amount of ink discharged in the setting A is 100% as described above, the amount of ink discharged in the last path in the setting B also becomes 25%.

In this case, the amount of ink discharged in the paths other than the last path is set to an amount smaller than 25%. For example, in the case of the illustrated setting B, the amount of ink discharged in the paths other than the last path is set to 20%.

When carrying out the operation of the multi-path method as described using FIGS. 2A to 2C, the amount of ink discharged in each path can be set as described above by indicating the amount of ink discharged in each main scanning operation from the regions 202a to 202d in the head unit 12 in FIG. 3B. In this case, for example, the amount of ink discharged from each of the regions 202a to 202d can be controlled (discharging amount control) by adjusting a ratio (duty) of the position of discharging the ink from each nozzle in each of the regions 202a to 202d. Furthermore, when the amount of ink is set as described above, the total amount of ink discharged in all the paths in the setting B becomes less than 100%. This is because the relative amount of when the total amount of ink discharged in the setting A is 100% is considered for the amount of ink. Thus, the total amount of ink may be less than 100% if a sufficient amount of ink can be discharged to form the layer of ink.

In the setting B, the amount of ink discharged in the paths other than the last path may be an amount other than 20%. In this case, for example, consideration is made to having the amount to about ⅕ to ⅘ (amount of 5 to 20% with respect to 100%) of the amount of ink discharged in the last path. In the paths other than the last path, it is considered more preferable to have the amount of ink to less than 20% to more appropriately prevent the dots from coming into contact, and the like. In this case, the amount of ink discharged in the paths other than the last path is preferably about ⅖ to ⅗ (amount of 10 to 15% with respect to 100%) of the amount of ink discharged in the last path. More specifically, for example, consideration is made to having the amount of ink discharged in the paths other than the last path to about 215 (amount of about 10% with respect to 100%) of the amount of ink discharged in the last path.

In the setting A and the setting B, the discharging amount of 25% is a maximum discharging amount (full discharging amount) that can be discharged in one path in the discharging ability of the inkjet head. In other words, in this case, the discharging amount in one path cannot be made greater than 25%. Thus, in the setting B, as great amount of ink as possible is discharged by having the discharging amount of ink to full discharging amount in the last path. Furthermore, the discharging amount in the paths other than the last path is made small by having the discharging amount of ink in the paths other than the last path to smaller than 25%.

When the discharging amount of ink in each path is set as in the setting B, the thickness of the layer of ink at the time point when each path is completed is changed by an amount corresponding to the amount of ink discharged in the relevant path. More specifically, as shown in FIG. 3A, in the setting B, the thickness of the layer of ink increases by 8 μm every time the ink is discharged in each path in the first to third paths in which the amount of ink discharged is small. In this case, the thickness of the layer of ink becomes large or 10 μm in the last fourth path. Thus, in this case, the ink corresponding to the thickness of 34 μm in total is discharged.

In this case as well, the thickness of the layer of ink at the time point when all the paths are completed becomes smaller than 34 μm by flattening. More specifically, for example, in the last path, consideration is made to having the thickness of the layer of ink after the flattening to about 30 μm by removing one part of the discharged ink with the flattening roller.

When carrying out the shaping through the multi-path method of the conventional configuration, for example, the phenomenon in which the height shifts at one part of the layer of ink is assumed to occur when the dot of the ink is formed at high density. More specifically, for example, at the surface-to-be-shaped of the 3D object, the dots may easily come into contact, and the like if the interval of the dots of the ink formed at the time of the main scanning operation of the same time is small. Furthermore, when the dots come into contact, and the like, the disarray in the state tends to easily occur in the layer of ink after the curing. Furthermore, if the interval of the dots is small, a slight shift in the positions of the adjacent dots may easily influence the state after the curing. Furthermore, the influence of variation in the discharging property of the inkjet head (habit in discharging property) may easily occur if the interval of the dots is small. Moreover, in this case, curved flight may easily occur by the influence of the closely flying ink (ink droplet) during the flight from the discharging to the landing as the ink is discharged at high density. As a result, shift in the landing position may occur, and disarray in the state may occur in the layer of ink after the curing.

On the contrary, in the present example, the amount of ink discharged is made small in the first to third paths, as in the setting B described above. According to such a configuration, for example, the contact of the dots can be prevented from easily occurring in the first to third paths. Thus, for example, the portion forming by the third path in the layer of ink can be appropriately formed at higher precision. Furthermore, in this case, the respective dots can be more appropriately formed in a matted state same as the design state, for example, by discretely forming the dots of the ink. Moreover, when discretely forming the dots, the landing positions are more randomly dispersed, and thus unevenness and the like are less likely to occur. Thus, the portion formed in each path other than the last path to carry out the flattening can be more uniformly and appropriately formed at higher precision.

In this case, the portion formed in the paths other than the last path can be considered as a base portion formed before the path to carry out the flattening. In this case, for example, such a base portion can also be said as being more uniformly formed at higher precision. In this case, the spreading manner after the landing can be made more even for the ink discharged in the last path by discharging the ink in the last path on such a base. The layer of ink can be more appropriately formed at high precision by carrying out flattening in such a state.

In this case, a state in which a locally high portion, and the like does not easily form can be realized for the base portion. Thus, according to such a configuration, for example, the contact of the cured ink dot and the flattening roller 106 (see FIGS. 1A to 1C) can be appropriately prevented from occurring.

When considered from the standpoint of preventing the dots from coining into contact in each path, for example, it can be assumed to reduce the discharging amount of ink even in the last path and reduce the amount of ink discharged in all the paths. However, if even the discharging amount in the last path to carry out the flattening is reduced, the amount of ink scraped off at the time of flattening is reduced, and the operation of flattening may not be appropriately carried out. Consideration is also made that the allowable degree (margin) becomes small, and the like in the adjustment of the flattening roller 106 at the time of flattening. When the amount of ink discharged in all the paths is reduced, consideration is made that the total amount of ink discharged in all the paths is greatly reduced, and the time required for the shaping is greatly increased, and the like.

On the contrary, in the present example, the thickness of the portion formed in the last path can be appropriately and sufficiently ensured, similar to the case of the setting A, for example, by having the discharging amount in the last path to carry out the flattening greater than in the previous paths. Thus, for example, the flattening can be appropriately carried out at high precision. Furthermore, the total amount of ink discharged in all the paths can be prevented from greatly reducing by discharging more ink in the last path. Thus, according to the present example, for example, the layer of ink can be more appropriately formed at high precision while appropriately carrying out flattening.

In this case, the amount of ink removed at the time of flattening may be differed, for example, from when discharging the ink as in the setting A. For example, the amount of ink removed at the time of flattening may be reduced in a range the allowable degree of the operation of flattening can be ensured. More specifically, in the case of the setting B of FIG. 3A, the thickness corresponding to the amount of ink removed at the time of flattening is 4 μm, which is less than 5 μm in the case of the setting A.

Furthermore, consideration is made to having the amount of ink discharged in the first to third paths slightly greater than the setting B and having the amount of ink removed at the time of flattening smaller so that the thickness after the flattening becomes the same as the setting A, depending on the demanded precision of shaping and the configuration of the shaping device 10 (see FIGS. 1A to 1C). In this case, for example, consideration is made to discharging the ink corresponding to the thickness of about 38 μm in a total of four paths and having the thickness after the flattening to 35 μm, and the like. According to such a configuration, for example, the respective layers of ink can be appropriately formed at high precision without lowering the speed of shaping.

Next, a supplementary explanation, and the like on the features of the present example will be described. As described above, in the present example, the discharging amount of ink in the first to third paths of the four paths carried out to form one layer of ink is less than that in the fourth path. Considering such a feature in a more generalized manner, the comparison in the amount of ink discharged in each path can also be considered by comparing a unit area discharging amount of the ink. In this case, the unit area discharging amount is, for example, the amount of ink discharged per unit area in one main scanning operation with respect to the region to which the ink to become the material of shaping is to be discharged. The amount of ink discharged per unit area is, for example, the total amount of ink discharged from the plurality of inkjet heads in the head unit 12.

In this case, the setting of the amount of ink carried out in the present example can also be considered as, for example, a configuration of having the unit area discharging amount in some main scanning operations less than the unit area discharging amount in the other main scanning operations in the plurality of main scanning operations carried out with respect to each position in the surface-to-be-shaped of the 3D object. When configured in such a manner, for example, the coupling of dots, and the like can be prevented from easily occurring by reducing the unit area discharging amount in some main scanning operations. Furthermore, even if the dots are brought into contact to a certain extent, the influence of contact can be reduced. Thus, when configured in such a manner, for example, the state of the surface-to-be-shaped of the 3D object can be appropriately arrayed by carrying out the main scanning operation with the reduced unit area discharging amount. The disarray in the state of the layer can be prevented from easily occurring even when the unit area discharging amount is increased by carrying out the other main scanning operations at the timing when the state of the surface-to-be-shaped is arrayed. Thus, according to such a configuration, for example, the layer of ink can be more appropriately formed at high precision. This configuration can be considered as the configuration of preventing the portion of disarrayed state from continuously overlapping in the layering direction by including the main scanning operation of reduced ink discharging amount in between instead of increasing the discharging amount of ink in all the main scanning operations.

Furthermore, in this case, in the operation of the multi-path method, it is preferable to have the unit area discharging amount in some paths less than the unit area discharging amount in other paths in the plurality of paths carried out to form one layer of ink at the time of forming at least some layers of ink. According to such a configuration, for example, the respective layers of ink can be more appropriately formed at high precision while suppressing the disarray of the state.

Moreover, in this case, it is preferable to have the unit area discharging amount in the path for carrying out flattening sufficiently large, as described above. Therefore, when forming at least some layers of ink, it is considered preferable to have the unit area discharging amount in the last path of the plurality of paths carried out to form the layer of ink greater than the unit area discharging amount in the other paths. According to such a configuration, for example, the operation of flattening can be more appropriately carried out.

In this case, it is preferable to have the unit area discharging amount in the last path greater than the unit area discharging amount in any other paths. Furthermore, the unit area discharging amount is preferably reduced at least in the path carried out immediately after carrying out the flattening. Therefore, when forming at least some layers of ink, it is considered preferable to have the unit area discharging amount in the first path of the plurality of paths carried out to form the layer of ink less than the unit area discharging amount in the last path. According to such a configuration, for example, the dot of the ink formed first on the flattened surface-to-be-shaped, for example, can be more appropriately formed at high precision. Thus the disarray of the state can be further prevented from easily occurring even with respect to the portion formed with the subsequent paths.

In this case, consideration is made to having the unit area discharging amount the same for the other paths other than the last path, for example, as in the case shown as the setting B in FIG. 3A. In this case, when referring to the unit area discharging amount being the same, for example, this means that the unit area discharging amount is substantially the same according to the precision of shaping, and the like. According to such a configuration, for example, the discharging amount of ink in the paths other than the last can be appropriately set through a simpler control.

In a variant of the configuration of the shaping device 10, the unit area discharging amount may be differed for every path with respect to the plurality of paths carried out to form one layer of ink. In this case, for example, consideration is made to having the unit area discharging amount in the main scanning operation carried out first less than the unit area discharging amount in the main scanning operation carried out next. According to such a configuration as well, the layer of ink can be appropriately formed at high precision.

Therefore, according to the present example, for example, a stable layer with little disarray in the state can be more appropriately formed as the layer of ink configuring the 3D object by intentionally reducing the discharging amount in some paths rather than increasing the discharging amount in all the paths. The contact of the cured ink and the flattening roller, and the like, for example, thus can be prevented.

As also described above, in the present example, the full discharging is not carried out in the paths other than the last path and the amount of ink discharged is reduced when forming the respective layers of ink. In this case, compared to the case of carrying out the full discharging in all the paths, the layer of ink to be formed becomes thin if, for example, the amount of ink removed at the time of flattening is the same extent. As a result, the time required for shaping is also increased to a certain extent. Thus, the configuration of the present example can be considered as, for example, a configuration of carrying out shaping at a higher precision instead of lowering the shaping speed. Furthermore, in this case, a mode of shaping in which the shaping speed is prioritized and a mode of shaping in which the precision of shaping is prioritized may be selected in the shaping device 10 (see FIGS. 1A to 1C). In this case, in the mode of shaping in which the shaping speed is prioritized, for example, the full discharging is carried out in all the paths to shape the 3D object. In the mode of shaping in which the precision of shaping is prioritized, for example, the full discharging is carried out only in the last path to shape the 3D object when forming the respective layers of ink.

Next, a variant on the operation of the multi-path method will be described. In the description made above, the operation of the multi-path method has been described mainly for a case of setting the distance obtained by dividing the nozzle row length of the inkjet head by the number of paths as the feeding amount in the sub-scanning operation using FIGS. 2A to 2C, and the like. However, the operation of the multi-path method may use operations other than those described above. More specifically, for example, consideration can be made to using the operation of a small pitch multi-path method, which is the method of setting the feeding amount in the sub-scanning direction between the main scanning operations for the number of paths to a small pitch, and the like.

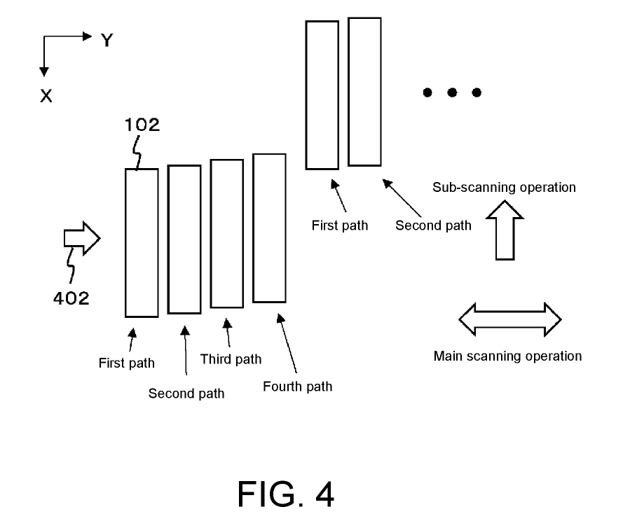

FIG. 4 is a view showing one example of the operation of the small pitch multi-path method, and shows one example of the operation of when the number of paths is four (four paths). Excluding the points described below, the configuration denoted with the same reference number as FIGS. 1 to 3 in FIG. 4 may have features same as or similar to the configuration in FIGS. 1 to 3.

When carrying out the operation of the small pitch multi-path method in four paths, four main scanning operations (paths), which is the number of paths, are carried out with respect to each position when forming one layer of ink, as shown in the figure. In this case, the main scanning operations of the first to fourth paths are carried out at the same time with respect to a region corresponding to the entire inkjet head 102 as indicated with the arrow 402. The sub-scanning operation in the feeding amount of small pitch is carried out between each main scanning operation of the first to fourth paths.

In this case, the small pitch is, for example, a distance smaller than the distance obtained by dividing the nozzle row length of the inkjet head 102 by the number of paths. More specifically, for example, consideration can be made to having the small pitch to smaller than or equal to about a few times the nozzle interval (nozzle pitch) (e.g., smaller than or equal to ten times the nozzle interval) in the nozzle row of the inkjet head. Such a small pitch may be, for example, a distance (e.g., ½ of nozzle interval) of smaller than the nozzle interval. Furthermore, consideration is also made to setting the small pitch to a distance obtained by adding the integral multiples of the nozzle pitch (e.g., one to ten times the nozzle pitch) and the distance smaller than the nozzle interval (e.g., ½ of the nozzle interval).

In the small pitch multi-path method, the sub-scanning operation in a greater feeding amount is carried out, as necessary, after carrying out the main scanning operation for the number of paths. More specifically, for example, when the width of the 3D object to be shaped in the sub-scanning direction is greater than the nozzle row length of the inkjet head, consideration is made to carrying out the sub-scanning operation in such a large feeding amount.

Furthermore, in the sub-scanning operation in the large feeding amount, for example, the feeding amount is set so as to shift the position of the inkjet head 102 in the sub-scanning direction by the nozzle row length from the position where the main scanning operation for the number of paths is carried out right before. In this case, for example, consideration is made to setting a large feeding amount so that the total feeding amount in the sub-scanning operation carried out after the first path in the main scanning operation for the number of paths carried out right before becomes equal to the nozzle row length. The first path in the main scanning operation for the number of paths carried out right before is the main scanning operation carried out immediately after the previous sub-scanning operation in the large feeding amount. Moreover, consideration can also be made to, for example, setting the large feeding amount so that a difference between the position of the inkjet head in the previous first path and the position of the inkjet head in the first path carried out next becomes equal to the nozzle row length for the relative position in the sub-scanning direction with respect to the 3D object.

Even when configured as above, for example, the shaping in the multi-path method can be appropriately carried out. In this case, the discharging amount of ink in each path can be commonly set with respect to the entire nozzle row instead of being set for every region of the nozzle row of the inkjet head. More specifically, for example, consideration is made to setting the discharging amount of ink small with respect to the entire nozzle row in the first to third paths, and setting the discharging amount of ink large with respect to the entire nozzle row in the last fourth path. According to such a configuration, for example, the discharging amount of ink in each path can be appropriately set in the operation of the small pitch multi-path method. Furthermore, in this case, for example, the usage rate of the nozzle can be more evened by commonly setting the discharging amount with respect to the entire nozzle row.

### INDUSTRIAL APPLICABILITY

The present disclosure can be suitably used in, for example, a shaping device.

What is claimed is:

1. A shaping device that shapes a stereoscopic 3D object, the shaping device comprising:
a discharging head that discharges a material of shaping;
a main scanning driver that causes the discharging head to carry out a main scanning operation of discharging the material of shaping while relatively moving with respect to the 3D object in a main scanning direction set in advance;
a layering direction driver that relatively moves the discharging head with respect to the 3D object in a layering direction, which is a direction in which the material of shaping is layered; and
a controller that controls operations of the discharging head, the main scanning driver, and the layering direction driver to execute an operation of shaping carried out by layering the material of shaping in the layering direction,
wherein the controller causes the discharging head to carry out a plurality of the main scanning operations with respect to each position within a plane orthogonal to the layering direction, and
defining an amount of the material of shaping discharged from the discharging head per unit area in one main scanning operation with respect to a region to which the material of shaping is to be discharged as a unit area discharging amount, the unit area discharging amount in some main scanning operations is less than the unit area discharging amount in the other main scanning operations in the plurality of main scanning operations carried out with respect to each position.

2. The shaping device according to claim 1, wherein
the 3D object is shaped through a layering and shaping method by layering a plurality of layers formed with the material of shaping, the respective layers being formed through the plurality of main scanning operations, and
when forming at least some layers, the unit area discharging amount in some main scanning operations is less than the unit area discharging amount in the other main scanning operations in the plurality of main scanning operations carried out to form one layer.

3. The shaping device according to claim 2, further comprising:
a flattener that flattens the layer,
wherein the flattener flattens the layer in at least a last main scanning operation of the plurality of main scanning operations carried out to form the layer when forming at least some layers.

4. The shaping device according to claim 3, wherein
when forming at least some layers, the unit area discharging amount in a first main scanning operation of the plurality of main scanning operations carried out to form the layer is less than the unit area discharging amount in the last main scanning operation.

5. The shaping device according to claim 3, wherein
when forming at least some layers, the unit area discharging amount in the last main scanning operation of the plurality of main scanning operations carried out to form the respective layers is greater than the unit area discharging amount in the other main scanning operations.

6. The shaping device according to claim 4, wherein
when forming at least some layers, the unit area discharging amount in the last main scanning operation of the plurality of main scanning operations carried out to form the respective layers is greater than the unit area discharging amount in the other main scanning operations.

7. The shaping device according to claim 5, wherein
the unit area discharging amount is the same for all the main scanning operations other than the last main scanning operation of the plurality of main scanning operations carried out to form the respective layers.

8. The shaping device according to claim 6, wherein
the unit area discharging amount is the same for all the main scanning operations other than the last main scanning operation of the plurality of main scanning operations carried out to form the respective layers.

9. The shaping device according to claim 5, wherein
for the plurality of main scanning operations carried out to form the respective layers, the unit area discharging amount in the main scanning operation carried out first is less than the unit area discharging amount in the main scanning operation carried out next.

10. The shaping device according to claim 6, wherein
for the plurality of main scanning operations carried out to form the respective layers, the unit area discharging amount in the main scanning operation carried out first is less than the unit area discharging amount in the main scanning operation carried out next.

11. A shaping method for shaping a stereoscopic 3D object, the shaping method causing a discharging head that discharges a material of shaping to carry out:
a main scanning operation of discharging the material of shaping while relatively moving with respect to the 3D object in a main scanning direction set in advance;
an operation of relatively moving with respect to the 3D object in a layering direction, which is a direction in which the material of shaping is layered, to execute an operation of shaping carried out by layering the material of shaping in the layering direction and causing the discharging head to carry out a plurality of the main scanning operations with respect to each position within a plane orthogonal to the layering direction; and
defining an amount of the material of shaping discharged from the discharging head per unit area in one main scanning operation with respect to a region to which the material of shaping is to be discharged as a unit area discharging amount, the unit area discharging amount in some main scanning operations is less than the unit area discharging amount in the other main scanning operations of the plurality of main scanning operations carried out with respect to each position.
